(19) United States
(12) Patent Application Publication
(10) Pub. No.: US 2007/0268467 A1
(43) Pub. Date: Nov. 22, 2007

(54) Exposure apparatus and semiconductor device manufacturing method

(76) Inventors: Makiko Katano, Yokohama-shi (JP); Takuya Kono, Yokosuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/802,291

(22) Filed: May 22, 2007

(30) Foreign Application Priority Data
May 22, 2006 (JP) 2006-142035

(51) Int. Cl. G03B 27/52

(52) U.S. Cl. 355/30; 355/53

(57) ABSTRACT

According to an aspect of the invention, there is provided an exposure apparatus including a chemical filter disposed in an air conditioning system to reduce a concentration of impurities in a gas, an optical component arranged to be exposed to the gas on a downstream side of the chemical filter, an irradiation section which irradiates the optical component with light of a wavelength equal to that of light for an exposure process, and a measurement section which measures a transmittance of the light applied from the irradiation section and transmitted through the optical component.

### CROSS-REFERENCE TO RELATED APPLICATIONS

This application is based upon and claims the benefit of priority from prior Japanese Patent Application No. 2006-142035, filed May 22, 2006, the entire contents of which are incorporated herein by reference.

### BACKGROUND OF THE INVENTION

1. Field of the Invention

The present invention relates to an exposure apparatus used for manufacturing a semiconductor device, and more particularly to an exposure apparatus and a semiconductor device manufacturing method which can monitor a life of a chemical filter.

2. Description of the Related Art

In an exposure apparatus which uses KrF, ArF lasers, an optical member such as a mirror or a lens is fogged depending on use. A cause of this problem may be Si-containing organic impurities, sulfuric acids, or ammonium in an installation environment of the exposure apparatus. To prevent the occurrence of such fog, measures which reduce an impurity concentration in an environment around the optical member by installing a chemical filter in an air conditioning system of the exposure apparatus have generally been taken.

However, no mechanism of managing a life of the chemical filter itself is disposed, and a user changes the chemical filter when fog of the optical member exceeds a permissible amount. In many cases, therefore, the optical member has to be changed at the time of changing the chemical filter, causing problems of cost for changing the optical member and a drop in operation rate of the exposure apparatus due to changing work.

Impurity concentrations can be measured before and after the chemical filter to determine its life. In this case, however, periodic measurement work has to be done, causing a problem of time and labor.

Jpn. Pat. Appln. KOKAI Publication No. 8-55774 discloses a technology in which a gas sensor is disposed on an upstream side of a chemical filter of an exposure apparatus to absorb impurities, the amount of substances absorbed by the gas sensor is calculated by resonance frequency measurement with the gas sensor, and a life of the chemical filter is determined based on the result of the calculation.

Jpn. Pat. Appln. KOKAI Publication No. 8-306599 discloses a technology in which when a gas passed through an exchange type filter for removing contaminants is supplied into a chamber accommodating an exposure apparatus, a section of a low contaminant removal capacity is disposed in a part of the filter, and filter exchanging time is predicted by using a contaminant detection means arranged on its downstream side.

Jpn. Pat. Appln. KOKAI Publication No. 9-280640 discloses a technology in which in a chemical filter of an exposure apparatus, the filter is divided into a plurality of filters in a thickness direction, a filter of an upstream side alone is discarded at the time of changing the filter, and a filter of a downstream side is used again.

Jpn. Pat. Appln. KOKAI Publication No. 2002-221507 discloses a technology in which an adsorption condition detection sensor having electrodes fixed to both sides of a filter member identical to a chemical filter and a reference sensor are mounted to a filter unit, and a change in impedance of each sensor is detected to determine when to change the filter.

Jpn. Pat. Appln. KOKAI Publication No. 2004-200402 discloses a technology in which in a chemical filter including multiple-stacked chemical filter sheets, a QCM gas sensor is disposed between the filter sheets to detect a basic gas, and a removal life of the filter is predicted based on a cumulative value of operation time of an air filter, and time expended by the gas sensor to reach a threshold value.

### BRIEF SUMMARY OF THE INVENTION

According to an aspect of the invention, there is provided an exposure apparatus comprising: a chemical filter disposed in an air conditioning system to reduce a concentration of impurities in a gas; an optical component arranged to be exposed to the gas on a downstream side of the chemical filter; an irradiation section which irradiates the optical component with light of a wavelength equal to that of light for an exposure process; and a measurement section which measures a transmittance of the light applied from the irradiation section and transmitted through the optical component.

According to another aspect of the invention, there is provided an exposure apparatus comprising: a plurality of chemical filters disposed in an air conditioning system to reduce concentrations of impurities in gases; a plurality of optical components arranged to be exposed to the gases on a downstream side of each of the chemical filters; an irradiation section which irradiates the plurality of optical components with light components of wavelengths equal to that of light for an exposure process; and a measurement section which measures a transmittance of each of the light components applied from the irradiation section and transmitted through each of the plurality of optical components.

According to another aspect of the invention, there is provided a semiconductor device manufacturing method for exposing a semiconductor substrate in an exposure apparatus comprising: applying light with a wavelength equal to that of an exposure process to an optical component arranged to be exposed to a gas on a downstream side of a chemical filter disposed in an air conditioning system in the exposure apparatus to reduce a concentration of impurities in the gas; and measuring a transmittance of the light transmitted through the optical component to detect a life of the chemical filter.

### BRIEF DESCRIPTION OF THE SEVERAL VIEWS OF THE DRAWING

FIG. 1 is a side view showing a schematic configuration of an exposure apparatus according to an embodiment of the present invention;

FIG. 2 is a side view showing a schematic configuration of an exposure apparatus according to a first modified example of the embodiment;

FIG. 3 is a side view showing a schematic configuration of an exposure apparatus according to a second modified example of the embodiment;

FIG. 4 is a side view showing a schematic configuration of an exposure apparatus according to a third modified example of the embodiment; and

FIG. 5 is a side view showing a schematic configuration of an exposure apparatus according to a fourth modified example of the embodiment.

### DETAILED DESCRIPTION OF THE INVENTION

The embodiments of the present invention will be described below with reference to the accompanying drawings.

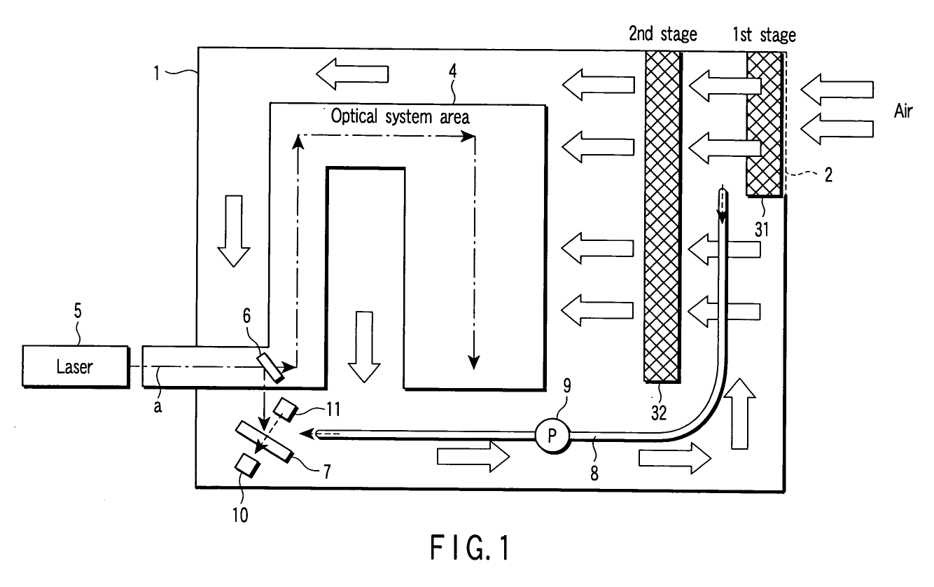

FIG. 1 is a side view showing a schematic configuration of an exposure apparatus according to an embodiment. The exposure apparatus of the embodiment is used for manufacturing a semiconductor device, and includes a chemical filter life monitor. The exposure apparatus exposes a semiconductor substrate.

An air intake port 2 is disposed in the backside of an exposure apparatus main body 1, and two stages of chemical filters 31, 32 are disposed near the air intake port 2 in the exposure apparatus main body 1. The two stages of chemical filters 31, 32 reduce a concentration of impurities in a gas of an air conditioning system.

An optical system area 4 on a downstream side of the chemical filters 31, 32 includes various optical members. The exposure apparatus main body 1 includes a laser beam source 5. An exposure laser beam a emitted from the laser beam source 5 is applied to the optical members in the optical system area 4.

In the exposure apparatus main body 1, a splitter mirror 6 is disposed on an optical path of the laser beam source 5, and a life detection optical component 7 made of SiO₂ or a fluorite is disposed on a reflection optical path of the splitter mirror 6. The splitter mirror 6 transmits the exposure laser beam a emitted from the laser beam source 5 through the optical system area 4, and splits and applies a part of the laser beam a to the optical component 7.

An air discharge tube 8 (guiding member) is disposed from a downstream side of the first-stage chemical filter 1 toward the chemical component 7. The air discharge tube 8 is provided with a pump 9. Accordingly, a gas on the downstream side of the chemical filter 31 whose life is to be detected is guided through the air discharge tube 8 to a surface of the life detection optical component 7 to be discharged to the same.

A transmittance measurement device 10 is disposed near the optical component 7 in the exposure apparatus main body 1. The transmittance measurement device 10 includes a mechanism of automatically and periodically measuring a transmittance of the laser beam from the splitter mirror 6 through the life detection optical component 7 or a transmittance of light from a transmittance measurement light source 11 through the optical component 7.

In the exposure apparatus configured in the aforementioned manner, upon suction of an external gas from the air intake port 2 into the exposure apparatus main body 1, the gas flows through the two stages of the chemical filters 31, 32 into the optical system area 4 to circulate in the exposure apparatus main body 1. A part of the gas passed through the first-stage chemical filter 31 is drawn through the air discharge tube 8 by an operation of the pump 9, and discharged from the air discharge tube 8 to the surface of the optical component 7.

When a removal rate of the chemical filter 31 drops to increase a concentration of impurities on the downstream side thereof, impurities in the gas discharged to the surface of the optical component 7 become substances of fogging the optical component 7 (fogging substances) by a laser beam applied to the optical component 7 to stick to the component surface. As a result, the transmittance of the optical component 7 drops.

The transmittance measurement device 10 periodically monitors the transmittance of the optical component 7 to plot a graph in which the abscissa indicates time and the ordinate indicates transmittance values. The transmittance measurement device 10 is set to display an alarm when the transmittance becomes equal to or less than a set value or when an absolute value of a change rate of the transmittance becomes equal to or more than a set value.

According to a general exposure apparatus, chemical filters are fixed in both of an air intake port and an air circulation path. According to the embodiment, however, by discharging the gas on the downstream side of the first-stage chemical filter 31 installed at the air intake port 2 to the optical component 7, the life of the first-stage chemical filter 31 can be detected. At this point of time, as the second-stage chemical filter 32 normally retains sufficient removal efficiency, no fog occurs in the optical system in the exposure apparatus main body 1. Thus, if the chemical filter 31 is changed at this stage, maintenance of the optical system is unnecessary. As the first-stage chemical filter 31 alone has to be changed, the work is easy, and an influence on the operation time of the apparatus can be reduced.

As the laser beam applied to the monitor optical component 7, not the exposure laser beam but light split for calibration in the exposure apparatus main body 1 can be used at timing when no calibration is carried out. A lamp (light source for transmittance measurement) 11 for applying light with a wavelength equal to that of light used for an exposure process may separately be disposed in the exposure apparatus main body 11 to apply light therefrom to the optical component 7. The monitor optical component 7 should preferably be installed in a return area of the air conditioning system in the exposure apparatus.

To fog the monitor optical component 7 more efficiently and quickly, the laser beam from the splitter mirror 6 may be applied to the optical component 7, and the light from the lamp 11 may be applied to the optical component 7 for transmittance measurement thereof. In this case, the laser beam from the splitter mirror 6 is used for expediting photoreaction of fogging, and the light from the lamp 11 is used for evaluating the transmittance. The laser beam from the splitter mirror 6 is always applied, or applied during exposure. As photoreaction depends on wavelengths of light components, when no exposure laser beam is used, a laser beam source for generating a laser beam with a wavelength equal to that of the exposure laser beam, or a lamp which includes light components with many equal wavelengths may be used. Transmittance measurement may be periodically carried out (e.g., daily), and light may be applied from the lamp 11 only during the measurement. A wavelength of light from the lamp 11 is basically equal in wavelength to the exposure laser beam. However, light with another wavelength can be used as long as there is a correlation with a transmittance change in the exposure laser beam.

By increasing an air discharge flow rate, the detection sensitivity can be increased, and thus the life of the chemical filter can be detected at an early stage.

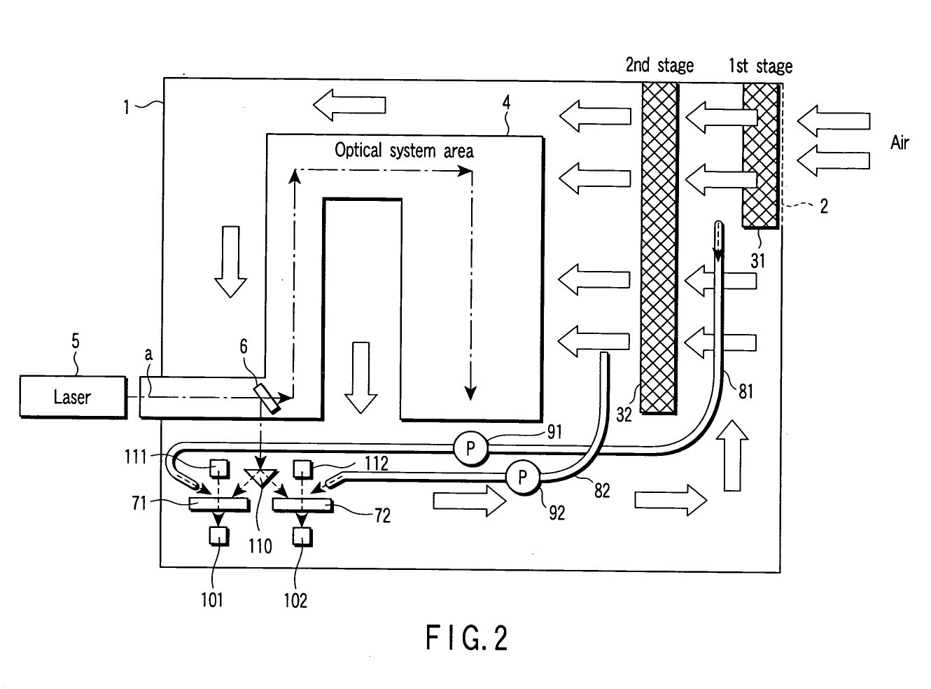

FIG. 2 is a side view showing a schematic configuration of an exposure apparatus according to a first modified example of the embodiment. When a plurality of chemical filters are installed, as shown in FIG. 2, air discharge tubes 81, 82 can be disposed for atmospheres on downstream sides of chemical filters 31, 32 to monitor the plurality of chemical filters. In this case, optical components 71, 72 for life detection are disposed at monitor points corresponding to the chemical filters 31, 32. A set of the laser beam source, lamp, and transmittance measurement device, or such components may be used for both of the chemical filters 31, 32. Two sets thereof may be used for the chemical filters 31, 32, respectively. In FIG. 2, lamps 111, 112, and transmittance measurement devices 101, 102 are respectively disposed for the chemical filters 31, 32.

When a laser beam from a laser beam source 5 is used as laser beams to be applied to the optical components 71, 72, a part of an exposure laser beam a emitted from the laser beam source 5 is split by a splitter mirror 5 and a light splitter component 110 to be applied to the optical components 71, 72. The transmittance measurement device 101, 102 include mechanisms for automatically and periodically measuring transmittances of laser beams from the light splitter component 110 through the optical components 71, 72 for life detection or transmittances of light components from the lamps (light sources for transmittance measurement) 111, 112 through the optical components 71, 72 to monitor transmittance values.

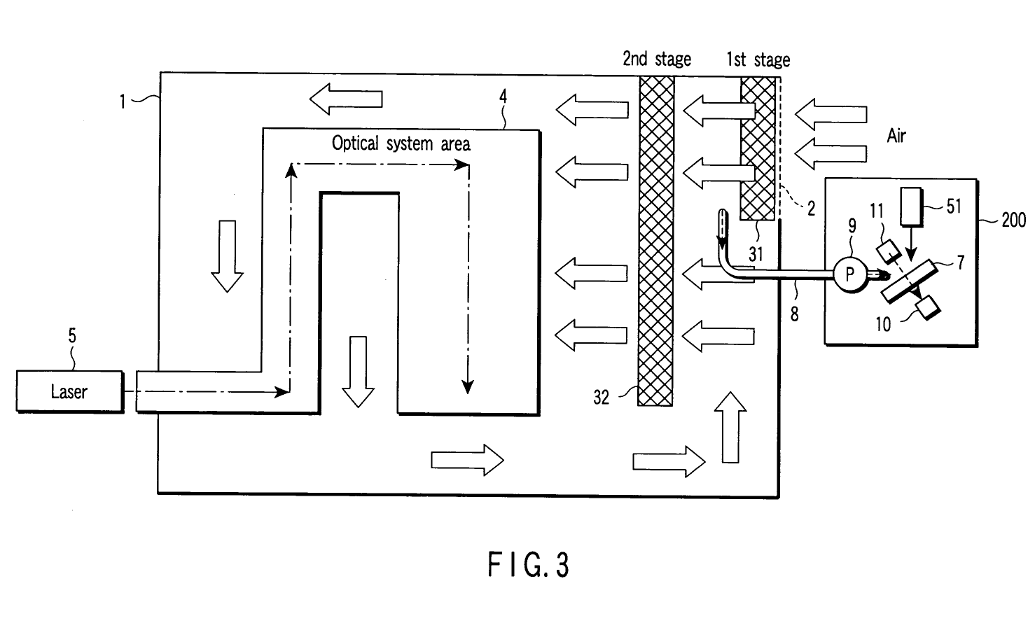

FIG. 3 is a side view showing a schematic configuration of an exposure apparatus according to a second modified example of the embodiment.

As shown in FIG. 3, an external unit 200 that includes a laser beam source 5 or a lamp 11, an optical component 7 for life detection, and a transmittance measuring device 10 is externally mounted to an exposure apparatus main body 1, and an air discharge tube 8 is derived from a downstream side of a chemical filter 31 in the exposure apparatus main body 1 to the outside of the exposure apparatus main body 1 to be disposed toward the optical component 7 for life detection in the external unit 200. The transmittance measurement device 10 includes a mechanism for automatically and periodically measuring a transmittance of a laser beam from the laser beam source 51 through the optical component 7 for life detection or a transmittance of light from the lamp (light source for transmittance measurement) 11 through the optical component 7 to monitor a transmittance value.

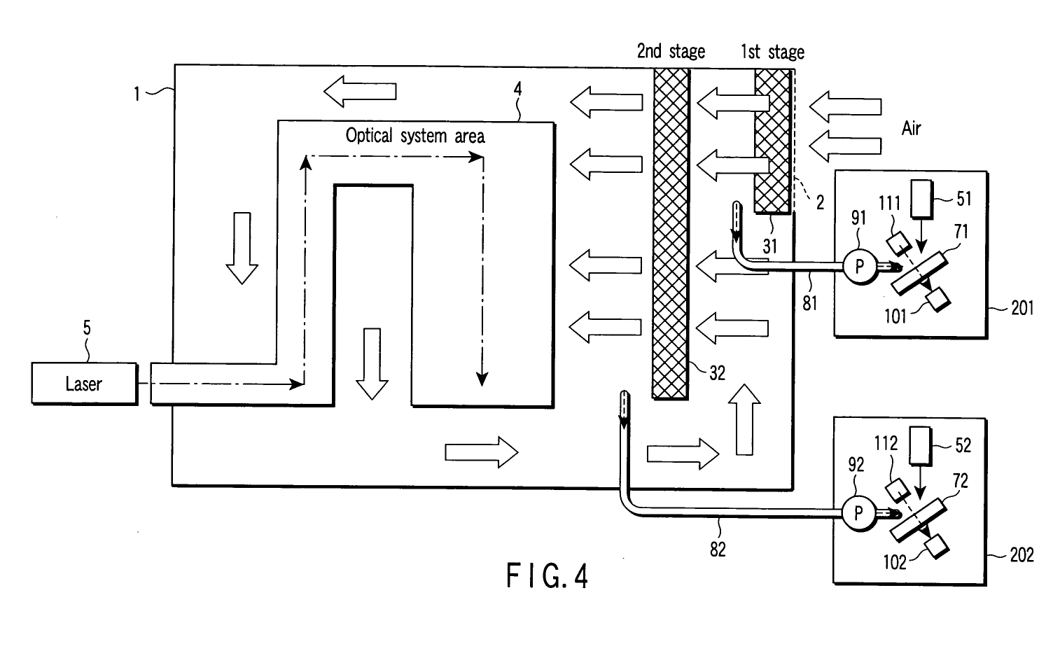

FIG. 4 is a side view showing a schematic configuration of an exposure apparatus according to a third modified example of the embodiment. When a plurality of chemical filters are installed in an exposure apparatus main body 1, as shown in FIG. 4, air discharge tubes 81, 82 can be disposed for atmospheres on downstream sides of the chemical filters 31, 32, and corresponding external units 201, 202 can be disposed. The external units 201, 202 respectively include laser beam sources 51, 52 or lamps 111, 112, optical components 71, 72 for life detection, and transmittance measurement devices 101, 102. The transmittance measurement devices 101, 102 include mechanisms for automatically and periodically measuring transmittances of laser beams from the laser beam sources 51, 52 through the optical components 71, 72 for life detection, or transmittances of light components from the lamps (light sources for transmittance measurement) 111, 112 through the optical components 71, 72 to monitor transmittance values.

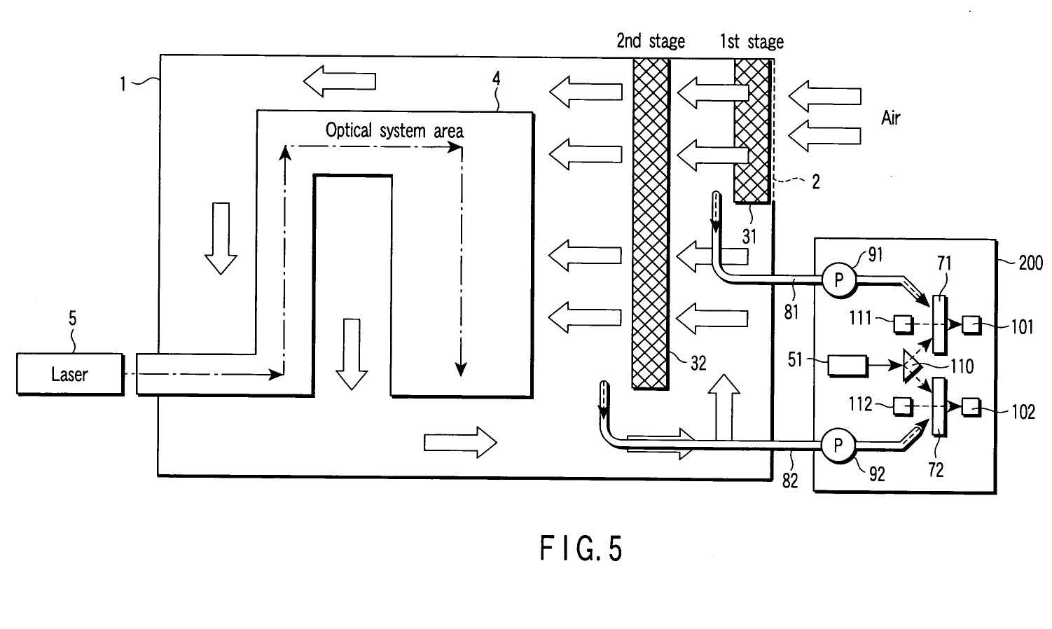

FIG. 5 is a side view showing a schematic configuration of an exposure apparatus according to a fourth modified example of the embodiment.

When a plurality of chemical filters are installed in an exposure apparatus main body 1, as shown in FIG. 5, air discharge tubes 81, 82 can be disposed for atmospheres on downstream sides of the chemical filters 31, 32, and one external unit 200 can be disposed therefor. The external unit 200 includes a laser beam source 51 and a light splitter component 110 or lamps 111, 112, optical components 71, 72 for life detection, and transmittance measurement devices 101, 102. The transmittance measurement devices 101, 102 include mechanisms for automatically and periodically measuring transmittances of laser beams from the light splitter component 110 through the optical components 71, 72 for life detection or transmittances of light components from the lamps (light sources for transmittance measurement) 111, 112 through the optical components 71, 72 to monitor transmittance values.

According to the second to fourth modified examples, without disposing a laser beam source, a lamp, an optical component for life detection, or a transmittance measurement device in the exposure apparatus, by simply installing a life monitor of an external unit, the life of a chemical filter can be detected.

According to the embodiment, the gas on the downstream side of the chemical filter is guided through the air discharge tube 8 to the optical component 7. However, a configuration can be employed in which the air discharge tube 8 is removed by arranging the optical component 7 near the chemical filter to be exposed to the gas on the downstream side of the chemical filter in the exposure apparatus main body 1.

As apparent from the foregoing, the embodiment provides the exposure apparatus which includes the mechanism for monitoring the life of the chemical filter used for the air conditioning system in the exposure apparatus. The monitor optical component is disposed in the exposure apparatus, light split from the exposure light source is applied while the gas is applied from the downstream side of the chemical filter to the component surface. The mechanism for measuring a transmittance of the monitor optical component is provided to monitor the transmittance.

When the removal rate of the chemical filter drops, and the concentration of impurities in the gas on the downstream side of the chemical filter increases, the monitor optical component is fogged to reduce a transmittance. Accordingly, by monitoring a change in the transmittance of the optical component, the life of the chemical filter can be detected.

The exposure apparatus of the embodiment facilitates detection of the life of the chemical filter mounted in the air conditioning system in the exposure apparatus. Before damage such as fogging of the process optical member of the exposure apparatus occurs, the life of the chemical filter is detected to enable determination of exchange timing. Thus, the cost of changing the optical component can be reduced, and a drop in operation rate of the exposure apparatus caused by maintenance such as changing or cleaning of the optical component can be prevented. According to the exposure apparatus which includes the two-stage chemical filters, by monitoring the life of the filter of the first stage (upstream side), the apparatus can be operated only by changing the filter of the first stage, and changing time and cost can be reduced.

Conventionally, life evaluation has been carried out by measuring concentrations of impurities in gases on upstream and downstream sides of the chemical filter. Thus, the measurement has needed much time, labor and cost, and much time has passed before a result of the measurement is obtained. According to the embodiment, however, the life detection can be carried out in real time without much time and labor, and without great cost.

According to the embodiment, it is possible to provide an exposure apparatus and a semiconductor device manufacturing method which can easily detect a life of the chemical filter used for an air conditioning system in the exposure apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An exposure apparatus comprising:
a chemical filter disposed in an air conditioning system to reduce a concentration of impurities in a gas;
an optical component arranged to be exposed to the gas on a downstream side of the chemical filter;
an irradiation section which irradiates the optical component with light of a wavelength equal to that of light for an exposure process; and
a measurement section which measures a transmittance of the light applied from the irradiation section and transmitted through the optical component.

2. The exposure apparatus according to claim 1, further comprising another chemical filter on the downstream side of the chemical filter.

3. The exposure apparatus according to claim 1, wherein the irradiation section includes a laser beam source.

4. The exposure apparatus according to claim 1, wherein the irradiation section splits the light used in the exposure process to irradiate the optical component.

5. The exposure apparatus according to claim 1, further comprising a guiding member which guides the gas on the downstream side of the chemical filter to a surface of the optical component.

6. The exposure apparatus according to claim 5, wherein the guiding member includes a tube.

7. The exposure apparatus according to claim 5, wherein the guiding member includes a pump.

8. The exposure apparatus according to claim 1, wherein the measurement section outputs an alarm when the transmittance becomes equal to or less than a set value or when an absolute value of a change rate of the transmittance becomes equal to or more than a set value.

9. The exposure apparatus according to claim 1, wherein the optical component, the irradiation section, and the measurement section are included in a unit.

10. An exposure apparatus comprising:
a plurality of chemical filters disposed in an air conditioning system to reduce concentrations of impurities in gases;
a plurality of optical components arranged to be exposed to the gases on a downstream side of each of the chemical filters;
an irradiation section which irradiates the plurality of optical components with light components of wavelengths equal to that of light for an exposure process; and
a measurement section which measures a transmittance of each of the light components applied from the irradiation section and transmitted through each of the plurality of optical components.

11. The exposure apparatus according to claim 10, wherein the irradiation section includes a laser beam source.

12. The exposure apparatus according to claim 10, wherein the irradiation section splits the light used in the exposure process to irradiate the plurality of optical component.

13. The exposure apparatus according to claim 10, further comprising a plurality of guiding members which guide the gases on the downstream sides of the plurality of chemical filters to surfaces of the plurality of optical components, respectively.

14. The exposure apparatus according to claim 13, wherein each of the plurality of guiding members includes a tube.

15. The exposure apparatus according to claim 13, wherein each of the plurality of guiding members includes a pump.

16. The exposure apparatus according to claim 10, wherein the measurement section outputs an alarm when the transmittance becomes equal to or less than a set value or when an absolute value of a change rate of the transmittance becomes equal to or more than a set value.

17. The exposure apparatus according to claim 10, wherein the plurality of optical components, the irradiation section, and the measurement section are included in a unit.

18. A semiconductor device manufacturing method for exposing a semiconductor substrate in an exposure apparatus comprising:
applying light with a wavelength equal to that of an exposure process to an optical component arranged to be exposed to a gas on a downstream side of a chemical filter disposed in an air conditioning system in the exposure apparatus to reduce a concentration of impurities in the gas; and
measuring a transmittance of the light transmitted through the optical component to detect a life of the chemical filter.

19. The method according to claim 18, further comprising guiding the gas on the downstream side of the chemical filter to a surface of the optical component.

20. The method according to claim 18, further comprising outputting an alarm when the transmittance becomes equal to or less than a set value or when an absolute value of a change rate of the transmittance becomes equal to or more than a set value.
